(19) United States
(12) Patent Application Publication
(10) Pub. No.: US 2006/0103053 A1
(43) Pub. Date: May 18, 2006

(54) Injection perform transfer improvement

(75) Inventor: Robert Johnston, Dover, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 10/986,065

(22) Filed: Nov. 12, 2004

(51) Int. Cl. B28B 7/12

(52) U.S. Cl. 264/335; 425/436 R

(57) ABSTRACT

A take-off tube assembly for transferring a preform and methods of use are discussed. The assembly has walls defining a receptacle, and the receptacle has an open end with a cross sectional area. A preform guide is located along the walls of the receptacle, the preform guide having an open end with a cross sectional area smaller than the cross sectional area of the receptacle. A vacuum inlet is also be present, allowing connection of the assembly to a vacuum so that a vacuum draw can facilitate transfer of the preform to the take-off tube.

### BACKGROUND OF THE INVENTION

1. Field of the Invention

The present invention relates generally to an apparatus for transferring a preform, and more particularly a take-off tube assembly comprising a receptacle that includes a preform guide and is adapted to receive the preform.

2. Background Information

Injection blow molding can be a two step process that requires the use of an injection molded preform to develop the final product. As part of the blow molding process, injection molded preforms must be removed from the mold. This can be accomplished by transferring the preform from the mold to a take-off tube. A cylindrical receptacle within the tube is used to receive the preform. The take-off tube assembly also comprises a vacuum inlet so that a vacuum can be connected, thus creating sufficient force to pull the preform into the receptacle. Once transfer is complete, the preform can be used in further applications.

The shape of preforms varies and can depend on the container that is ultimately formed. For some containers, preforms are conical in shape and do not transfer well. This is due to the distance between the tapered end of the preform and the walls at the open end of the receptacle of the take-off tube, which causes a delay in the tube's ability to build a vacuum. This delay slows the transfer of the preform, since it takes longer to create the vacuum force, or draw, that pulls the preform into the receptacle.

For example, as shown in FIG. 1, when a prior art take-off tube assembly 001 approaches preform 002 to facilitate transfer, there is a distance, A′ from the tapered end 014 of the preform 002 to the walls 004 of the open end 008 of the receptacle 006. The take-off-tube is adapted for connection to a vacuum by vacuum inlet 018. The excessive distance A′ creates a delay in the build-up of the vacuum, causing a delay in the transfer process.

An attempted solution has been to use air to blow the preform into the tube, but this technique has experienced limited success and presents maintenance issues. The provision of air requires additional components, energy, upkeep, and space. Another solution is the use of two-piece assembly with dual motion to approach and remove the preform. Unfortunately this technique is very expensive.

Thus there is a need in the art to eliminate the delay or failure in transfer of injection molded preforms to the take-off tube assembly in a cost-effective manner. What is needed then is a transfer system that can be used to efficiently transfer tapered or conical preforms. An effective transfer apparatus should be able to overcome the delay in buildup of the vacuum and guide the preform, thus expediting transfer of the preform to the tube.

### BRIEF SUMMARY OF THE INVENTION

The present invention is directed to a take-off tube assembly comprising walls defining a receptacle. The receptacle has an open end with a cross-sectional area. A preform guide is located along the walls of the receptacle, and the preform guide has an opening with a cross-sectional area smaller than the cross-sectional area of the open end of the receptacle. The assembly also has a vacuum inlet allowing for connection to a vacuum.

The preform guide of the assembly increases the efficacy of a vacuum when a vacuum is supplied to the vacuum inlet. The preform guide is also flexible and provides guidance during the transfer process.

Along the walls of the receptacle there can be a recess for receiving a portion of the preform guide that might be pushed inward when a preform enters the take-out tube. The receptacle walls can further comprise a channel for containing a cooling liquid. In one embodiment, the cooling liquid is water.

The take-off tube assembly is adapted for transferring a preform wherein the portion of the preform initially entering the take-off tube assembly has a cross-sectional area less than the cross-sectional area of the receptacle. The preform may be tapered where the preform enters the open end of the receptacle. Further, the preform can have external diameter smaller than the diameter of the open end of the receptacle.

The preform guide can be located along an upper portion of the receptacle, for example, at the open end of the receptacle.

The present invention also speaks to methods for tranferring and accelerating transfer of a preform using the take-off tube assembly described. The invention further speaks to an apparatus for manufacturing plastic containers, wherein the apparatus includes the take-off assembly.

The present invention improves upon devices and methods available in the art by eliminating transfer delays without the addition of energy-consuming and maintenance-intensive devices. The take-off tube assembly of the present invention is easily adapted for use with a variety of preforms, particularly those that are conical in shape or tapered. Furthermore, the invention is cost effective.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a cross-sectional side view depicting the process of preform transfer to a take-off tube assembly using a prior art transfer apparatus;

FIG. 2A is a cross-sectional side view depicting the take-off tube assembly of the present invention;

FIG. 2B is a top view of the take-off tube assembly, illustrating the diameter of the take-off tube assembly receptacle and the smaller diameter of the preform guide opening;

FIG. 3 is a cross-sectional side view depicting the process of preform transfer to a take-off tube assembly of the present invention;

FIG. 4A is a cross-sectional side view depicting the completed process of transfer, with the preform in the receptacle of the take-off tube;

FIG. 4B is a detail view of the preform guide and a portion of the receptacle wall of the present invention when the preform is inside the take-off tube;

FIG. 5A illustrates an alternate embodiment of a preform guide attached to the walls of the take-off tube receptacle;

FIG. 5B illustrates another embodiment of a preform guide attached to the walls of the take-off tube receptacle.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

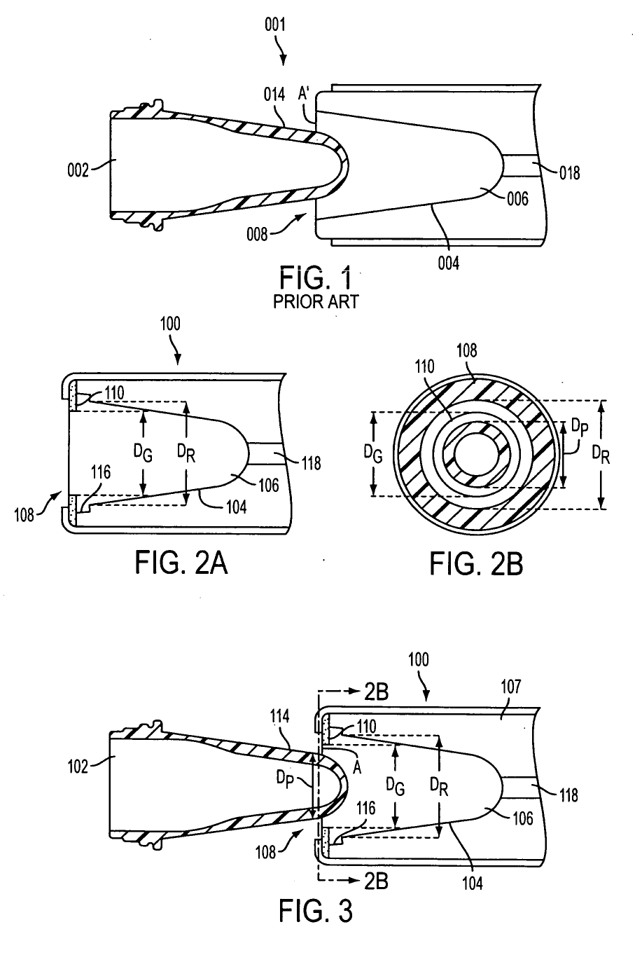

As depicted in the exemplary embodiment shown in FIG. 2A, the present invention is a take-off tube assembly 100 for transferring a preform 102 (See FIG. 3). The take-off tube assembly 100 includes walls 104 defining a receptacle 106, and a channel 107 within those walls for containing a cooling substance. Generally the cooling substance is water, but other coolants can be used.

The receptacle of the take-off tube assembly has an open end 108. A preform guide 110 is present along the walls 104 of the receptacle 106. FIG. 2B is a cross section taken from FIG. 2A illustrating the diameter of the receptacle opening, D_{R}, the diameter of the preform opening D_{P}, and the diameter of the preform guide opening, D_{G}. The diameter D_{R} of the receptacle open end is larger than diameter D_{G} of the preform guide opening. As a result, the cross-sectional area of the preform guide opening is smaller than the cross sectional area of the receptacle open end.

The invention contemplates preform guides of various sizes to accommodate specific preform designs. In addition to being round, the preform guide may be square, oval, polygonal, etc.

The preform guide 110 can be made of a flexible material and can be present anywhere along the walls 104 of the receptacle 106. In the embodiment illustrated in FIG. 2A., the preform guide is present along the entire perimeter of the open end of the receptacle 106 so that air doesn't escape. Alternatively, the preform guide 110 can be present within the receptacle 106. Typical materials for the preform guide include any suitable flexible material such as rubber, plastic, nylon, etc.

The preform guide 110 provides guidance of the preform throughout the transfer process. First, the preform guide 110 guides the preform to the receptacle 106. Second, the preform guide 110 creates a seal during transfer to the receptacle 106 to allow the vacuum to take maximum effect. Third, the preform guide 110 creates a seal during ejection, allowing the force of the blown air to take maximum effect.

As shown in FIG. 3, the take-off tube 100 assembly is adapted for receiving a preform 102. The take-off tube assembly 100 is also adapted for connection to a vacuum through the vacuum inlet 118, to create a vacuum draw that pulls the preform 102 into the receptacle 106 of the take-off tube assembly 100. Note that air flow through the vacuum 118 can also be reversed to blow air into the take-off tube receptacle 106 and eject the preform 102.

The preform 102 can be conical in shape, having a tapered end 114. Further, the preform 102 has a diameter D_{P}, which can be equivalent to or smaller than the diameter of the gasket, D_{G}. Due to its smaller diameter D_{P}, the tapered end of the preform also has a cross-sectional area smaller than the cross sectional area of the receptacle 106.

The preform guide 110 of the present invention is designed to overcome the delay in the buildup of the vacuum and provide guidance during the transfer process. The preform guide 110 reduces the diameter of the open end 108 of the receptacle 106 (from D_{R} to D_{G}). The reduction in diameter also results in a reduction in the cross-sectional area and size of the receptacle open end 108. Due to the reduced diameter at the open end of the receptacle 106, the distance A between the walls 104 of the open end 108 of the receptacle 106 and the tapered end 114 of the preform 102 is also reduced. The reduction in distance A, relative to that achieved with prior art take-off tubes (see A′, FIG. 1), allows the vacuum draw between the tube 100 and the preform 102 to build more quickly, facilitating transfer of the preform 102. Thus, the addition of the preform guide 110 increases the efficacy of the vacuum.

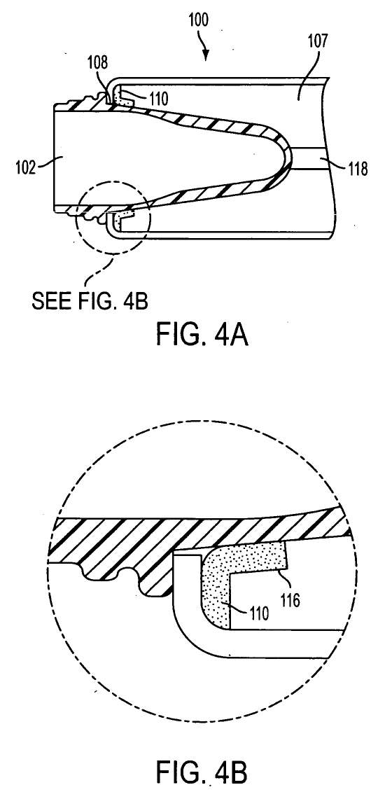

FIG. 4A depicts an embodiment of the transfer apparatus of the claimed invention when the preform 102 has been transferred to the take-off tube assembly 100. Contact of the preform 102 with the preform guide 110 causes the preform guide to bend, deform, or recede inwards toward the receptacle walls 104. The deformed preform guide 110 can now rest in the recess 116 along the wall 104 of receptacle 106.

FIG. 4B is an exploded view of the preform guide 110 and a portion of the receptacle wall 104 from FIG. 3. As illustrated in FIG. 3, the preform guide 110 is pushed into and rests in the recess 116 along the walls 104 of the receptacle 106. As in the illustrated embodiment, the preform guide 110 can be present at the open end 108 of the receptacle 106, with the recess 116 below the opening 112 of the gasket.

Along the walls 104 of the receptacle 106, below the preform guide 110, there can be an under-cut forming a recess 116 as shown in FIG. 2A. The recess 116 can receive the preform guide 110 when the entering preform 102 pushes the preform guide 110 towards the walls 104 of the receptacle 106, away from the open end 108. The recess 116 is on the internal side of the receptacle below the preform guide 110, for example, near the open end 108, as pictured.

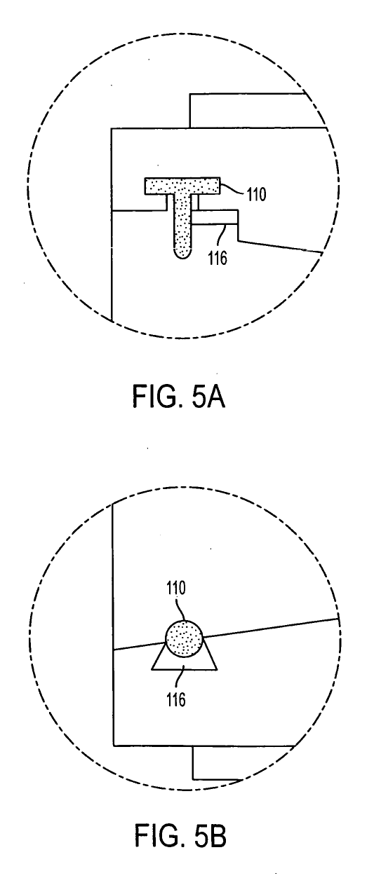

The preform guide 110 can be a variety of shapes and can be affixed to the receptacle 106 in a variety of ways. FIGS. 5A and 5B are two additional examples of the many types of preform guides 110 contemplated by the present invention. Again, the walls of take-off tube receptacle 106 can have a recess so that the preform guide 110 can be pushed back as the preform 102 slides into the take-off tube receptacle 106.

The take-off tube assembly includes a vacuum inlet, 118, so that a vacuum can be connected to the apparatus. The inlet can be placed at the end of the assembly opposite to the open end 108 of the receptacle 106. When connected to the assembly 100, the vacuum creates a force, a vacuum draw, that pulls the preform 102 into the receptacle 106 of the take-off tube assembly 100.

The take-off tube assembly 100 of the present invention can be a component of an apparatus for manufacturing a plastic container. One example of such an apparatus is a blow molding or an injection molding machine for molding preforms. The apparatus of the claimed invention can also be one for transferring the preform from the injection molding machine to the blow molding machine, or for picking up preforms and transferring them to the blow molding machine, conveyor, or other product handling equipment. Further, any unit or portion of an apparatus for manufacturing a plastic container that is involved in transferring a preform is the subject of the claimed invention.

The present invention also includes methods of transferring a preform 102 comprising use of the take-off tube assembly 100 of the invention. The invention further speaks to methods of transfer of a preform 102 by providing the take-off tube assembly 100 of the invention and applying a vacuum to the tube to facilitate transfer.

The invention is particularly suited to the use of conical or tapered preforms. However, the take-off tube assembly 100 can be adapted to receive preforms of varying shapes, i.e. square, rectangular, polygonal, etc. by varying the shape of the preform guide 110 such that the shape of the opening 112 corresponds to the shape of the preform 102 where the preform enters the open end 108.

Preforms compatible with the take-off tube assembly 100 of the present invention can also vary in size. Additionally, the preform guide can be adapted to suit the size of the preform. For example, to accomplish transfer of a preform with a very small diameter, a larger preform guide can be placed in the receptacle. Likewise, if the preform has a larger diameter, a smaller preform guide can be inserted into the take-off tube assembly receptacle 106. Thus, a single take-off tube assembly 100 can be adopted for a wide variety of preform sizes and shapes.

The invention improves upon the prior art by providing a preform guide along the walls of the open end of the take-off tube assembly that bridges the gap between the tapered ends of a preform and the walls of the open end of the receptacle. The reduction or elimination of this gap facilitates the formation of a vacuum during the transfer of the preform from the mold to the take-off tube assembly receptacle. The preform guide can bend to accommodate the section of the preform with a larger diameter than the end that initially enters the tube. Further, the preform guide provides guidance throughout the transfer process, both as the preform approaches the receptacle, and during ejection.

During the process of transfer, the preform is still warm and malleable and can sometimes get bent. In order to eject the preform, a vacuum force can be reversed from suction to blow mode to remove the preform from the take-off tube receptacle. If the preform is bent or dented, air can escape from the receptacle, rendering the pressure created by the blown air ineffective. The presence of a preform guide in contact with the sides of the preform creates a seal so that air cannot escape, allowing the force of the blow to take maximum efffect. Thus, the preform guide provides assistance during ejection as well as transfer.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A take-off tube assembly comprising:
a. walls defining a receptacle, said receptacle having an open end with a cross-sectional area;
b. a preform guide located along the walls of the receptacle, said preform guide having an opening defining a smaller cross-sectional area than the cross-sectional area defined by the open end of the receptacle; and
c. a vacuum inlet.

2. The take-off tube assembly of claim 1 wherein said preform guide increases the efficacy of a vacuum when a vacuum is supplied to the vacuum inlet.

3. The take-off tube assembly of claim 1 wherein said preform guide is flexible.

4. The take-off tube assembly of claim 1 wherein the preform guide provides guidance during the transfer process.

5. The take-off tube assembly of claim 1 wherein the walls of the receptacle further comprise a recess for receiving a portion of the preform guide pushed inward when a preform enters the take-out tube.

6. The take-off tube assembly of claim 1 wherein the walls of the receptacle further comprise a channel for containing a cooling liquid.

7. The take-off assembly of claim 6 wherein the cooling liquid is water.

8. The take-off tube assembly of claim 1 adapted for transferring a preform wherein the portion of the preform initially entering the take-off tube assembly has a cross-sectional area less than the cross-sectional area of the receptacle.

9. The take-off tube assembly of claim 8 wherein the preform is tapered where the preform enters the open end of the receptacle.

10. The take-off tube assembly of claim 8 adapted for transferring a preform having an external diameter smaller than the diameter of the open end of the receptacle.

11. The take-off tube assembly of claim 1 wherein said preform guide is located along an upper portion of the receptacle.

12. The take-off tube assembly of claim 1 wherein said preform guide is located at the open end of the receptacle.

13. A method for accelerating transfer of a preform comprising transferring the preform using the take-off tube assembly of claim 1.

14. A method for transferring a preform to a take-off tube assembly comprising:
a. providing a take-off tube assembly having:
i. a receptacle;
ii. a preform guide at an open end of said receptacle, thereby reducing the distance between the open end of the receptacle and the preform; and
b. applying a vacuum to said take off tube assembly, said vacuum facilitating transfer of the preform to the receptacle.

15. The method of claim 14 wherein said preform guide is flexible.

16. The method of claim 14 wherein the walls of the tube further comprise a recess for receiving a portion of the preform guide pushed inward by a preform entering the tube.

17. The method of claim 14 wherein the preform is tapered where the preform enters the open end of the receptacle.

18. An apparatus for manufacturing plastic containers comprising:
a. a take-off tube assembly comprising:
i. walls defining a receptacle,
ii. the receptacle having an open end defining a cross-sectional area;
iii. a preform guide located along the walls of the receptacle, said preform guide defining a smaller cross-sectional area within the cross-sectional area defined by the open end of the receptacle;
thus reducing the effective area of the open end,
iv. a vacuum inlet; and
b. a preform.

19. The apparatus of claim 18 wherein said preform guide is flexible.

20. The apparatus of claim 18 wherein the walls of the receptacle contain a recess for receiving a portion of the preform guide pushed inward by a preform entering the take-off tube.

21. The apparatus of claim 18 wherein the preform is tapered where the preform enters the open end of the receptacle.

22. A method for transferring a preform to a take-off tube assembly comprising:
a. providing a preform;
b. providing a take-off tube assembly having:
i. walls defining a receptacle;
ii. a preform guide at an open end of said receptacle, thereby reducing the distance between the open end of the receptacle and the preform; and
c. applying a vacuum to said take-off tube assembly for transferring the preform to the receptacle.

23. The method of claim 22 wherein said preform guide is flexible.

24. The method of claim 22 wherein the walls of the receptacle further comprises a recess for receiving a portion of the of preform guide pushed inward by a preform entering the tube.

25. The method of claim 22 wherein the preform is tapered where the preform enters the open end of the receptacle.
